(19) United States
(12) Patent Application Publication
(10) Pub. No.: US 2012/0039430 A1
(43) Pub. Date: Feb. 16, 2012

(54) NUCLEAR POWERED FACILITY THAT GENERATES CONSUMABLE FUELS

(76) Inventor: Cal R. ABEL, Atlanta, GA (US)

(21) Appl. No.: 13/210,518

(22) Filed: Aug. 16, 2011

Related U.S. Application Data
(60) Provisional application No. 61/374,227, filed on Aug. 16, 2010.

(51) Int. Cl. G21G 1/02; B01J 19/00

(52) U.S. Cl. 376/325; 422/162

(57) ABSTRACT

The present invention includes a system and method of producing consumable fuels generally including a thermal input device, a gasifier, a heat pump, and a product gas heat recovery device. Optionally, the system and method of the present invention includes a nuclear steam supply device as a thermal input. Optionally, the nuclear steam supply device includes a sodium fast reactor having a core outlet temperature of less than about 650° C.

### CROSS-REFERENCE TO RELATED APPLICATION

This application claims the benefit of U.S. Provisional Patent Application Ser. No. 61/374,227, filed Aug. 16, 2010, the entirety of which is hereby incorporated herein by reference for all purposes.

### TECHNICAL FIELD

The present invention relates generally to power plants and more particularly, to a nuclear powered facility designed to generate various liquid fuels and/or consumable gases.

### BACKGROUND OF THE INVENTION

Heat from a nuclear reactor may be employed to provide the energy necessary to perform various chemical reactions and/or generate electricity. For example, it is known that nuclear reactors can be utilized to produce various fuel sources, including hydrogen. However, nuclear power plants have been historically prevented from being used in process heat applications due to operational temperature limitations. For instance, existing commercial reactors are limited to working temperatures of about 280° C. and it is anticipated that the next generation of reactors will be restricted to working temperatures of about 550° C. Indeed, further advances past 650° C. are complicated by the physical limitations of the nuclear fuel and structural materials that are amenable for nuclear applications. Whereas, materials used in non-nuclear applications above 650° C. are well known, understood and developed.

Moreover, it has long been believed that in order for a nuclear reactor to be an economical source of heat for many chemical processes, the reactor must generally operate at temperatures higher than 700° C., which is higher than can be obtained with light water reactors or metal cooled reactors utilizing present day technology. For example, note U.S. Pat. No. 4,576,783, which discloses the use of a high temperature gas cooled reactor in an attempt to provide the higher reactor output temperatures that are believed to be required to perform such processes. Unfortunately, it has been discovered that such high temperature reactors are very expensive and difficult to build/maintain due to material limitations (among other factors). Presently, research is being directed to the development of materials that may eventually permit the feasible operation of high temperature gas cooled reactors for the production of consumable fuels. However, needs clearly exist for a nuclear solution that can be operated in the near term that is both feasible, economical and/or can operate with present day materials. It is to the provision of these needs and others that the present invention is directed.

### SUMMARY

The present invention offers a feasible and economical solution to energy production and encourages the reuse and/or retrofitting of much of the existing energy production infrastructure while achieving drastic reductions in CO₂ emissions. For instance, various aspects of the present invention are directed to repowering existing coal power plants using mid-temperature (˜500° C.) modular Sodium Fast Reactors (SFR) like General Electric-Hitachi's Super Power Reactor Innovative Small Module (S-PRISM), which is the non-water cooled reactor most ready for commercialization. One advantage of repowering coal power plants with such reactors is that much of the existing electricity and production infrastructure (including the coal mining and rail infrastructure) can continue to be utilized, while reducing CO₂ emissions on a megawatt for megawatt basis. Additionally, the present invention enables the conversion of coal (or other carbon-based feedstocks) into liquid fuels, such as gasoline, kerosene, diesel, etc. Moreover, it is believed that the present invention will allow the United States of America to be able to fully meet its primary energy needs without reliance on imported energy and will facilitate a reduction in greenhouse gas emissions by 50% from 2008 levels in the year 2050. It is believed that these reductions in greenhouse gas emissions can occur without limiting the primary energy input into the economy.

In one aspect, the present invention is a system for producing consumable fuels. The system includes a thermal input device to heat a working fluid, a heat pump, means for delivering the working fluid to a gasifier, and a product gas heat recovery device. The heat pump is operable to amplify the temperature of the working fluid. The gasifier converts a carbonaceous feedstock into at least one product fluid and the system utilizes at least a portion of the product fluid to produce a consumable fuel.

In another aspect, the present invention is a system for producing consumable chemical byproducts including a nuclear fueled steam supply device operable to produce steam. The system also includes at least one heat pump that can increase the temperature of the steam before it is delivered to a chemical reactor. Moreover, the system includes means for delivering the steam to the chemical reactor, wherein the steam undergoes at least one chemical reaction. The system is useful for producing at least one consumable chemical byproduct.

In yet another aspect, the present invention is a method of producing consumable fuels, including the following steps: (1) heating a working fluid using a nuclear reactor, (2) raising the temperature of the working fluid with a heat pump, (3) delivering the working fluid to a gasifier, wherein the gasifier converts a carbonaceous feedstock into at least one product fluid, (4) passing the product fluid through a product gas heat recovery device to at least partially recover heat from the product fluid, and (5) converting the product fluid into a consumable fluid.

In another aspect, the present invention includes a system for producing consumable chemical byproducts including a solar thermal energy supply device operable to produce steam. The system also includes at least one heat pump operable to increase the temperature of the steam before it is delivered to a chemical reactor. Additionally, the system includes means for delivering the steam to the chemical reactor, wherein the steam undergoes at least one chemical reaction. At least one consumable chemical byproduct is created by the at least one chemical reaction.

In still another aspect, the present invention includes a system for the generation of consumable fuels including a nuclear fission reactor to supply steam. The nuclear fission reactor has a core outlet temperature of less than about 650° C. The system also includes a gasifier to produce synthetic consumable fuels and the gasifier is operable at between about 600° C. and about 800° C. The system also includes a Brayton cycle heat pump to regulate gasifier conditions and a product gas heat recovery device to recover and/or cool the consumable fuels.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a generalized schematic of a facility according to a first example embodiment of the present invention.

FIG. 2 is a schematic of a particular nuclear facility according to another example embodiment of the present invention.

FIG. 3 is a schematic of an exemplary Dryer/Retort/Heat Recovery device used in conjunction with the nuclear facility of FIG. 2.

FIG. 4 is an alternative embodiment of the present invention for use with a Light Water Reactor (LWR)

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Generally, the system and method of the present invention utilizes nuclear fuel as a near infinite heat source to produce liquid fuels and/or methane (or other carbon-based gases) and/or hydrogen. As such, the facility discussed herein, along with numerous variations, provide an economic way of enhancing the capital recovery of a nuclear facility that is used for load by providing a synfuel cogeneration capability. In particular, the facility of the present invention is designed to fit into an existing coal plant that has been converted to utilize a nuclear reactor, but maintains its coal handling infrastructure. Thus, example embodiments of the present invention provide for the conversion of traditional coal plants to nuclear plants while eliminating—or minimizing—the stranded asset cost normally associated with the premature decommission of a coal fired plant. Alternatively, a nuclear facility according to the present invention can be used in greenfield applications. Additionally, the present invention provides for a zero-carbon heat source as the driving force for various chemical reactions—including, but not limited to, the creation of liquid fuels/gases from coal (or other carbon-based) inputs. In still other example embodiments, nuclear fuel can be replaced with at least one thermal input to provide the necessary heat for the desired reactions. For example, in alternative embodiments, the thermal input of the present invention can be a solar thermal energy system.

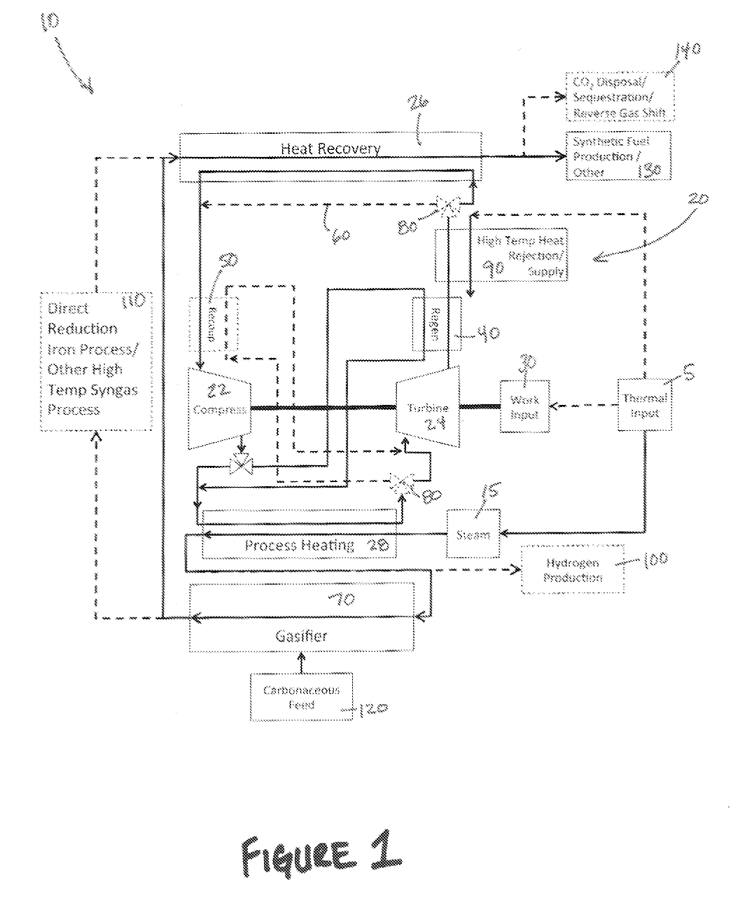

With specific reference now to the drawing figures, FIG. 1 depicts a generalized schematic diagram of a nuclear powered facility 10 according to example embodiments of the present invention (note that in alternative embodiments, a nuclear fission reactor can be replaced with a solar thermal system). In such example embodiments a heat pump 20 transfers heat from a heat recovery heat exchanger 26 to a working fluid. In preferred example embodiments, the working fluid is steam. Alternatively, methane or various other working fluids can be used in accordance with the present invention. The working fluid(s) are preferably transferred through the facility via piping formed from alloy 617, alloy 230, and/or stainless steel 316, but one of ordinary skill in the art will appreciate that other types of metallic or non-metallic pipes or various other means of transferring the same through the facility can be utilized as desired. In such embodiments in which steam is employed, the steam is heated by the heat pump 20 to a higher temperature with an input of work 30 from some external source (nuclear power module or other useful work input device). The heat pump 20 comprises, for example, a compressor 22, a turbine 24, a low temperature/low-pressure heat exchanger 26, and a high temperature/high-pressure heat exchanger 28. In preferred example embodiments, the working fluid in the heat pump 20 is super critical carbon dioxide (S—CO₂). However, in other embodiments, the working fluid can be any fluid capable of being compressed/expanded in a similar heat cycle. S—CO₂ is preferred because of reduced work input to compress the fluid near the critical point, which has been found to increase cycle efficiencies.

As depicted in FIG. 1, the facility also comprises regeneration 40 and can optionally include a recuperator 50. The recuperator may be added if there is a large temperature difference between the inlet of the heat recovery heat exchanger 26 and the inlet to the turbine 24. As depicted in the various embodiments included herein, such temperatures are close enough that the capital investment of a recuperating heat exchanger 50 is unlikely to be warranted. The depicted regenerative heat exchanger 40 and the optional bypass line 60 of the heat recovery heat exchanger 26 are for temperature control of the process heat. A gasifier 70 as shown in FIG. 1 preferably utilizes steam as a working fluid to transfer heat into and out of the gasifier and as a chemical reactant. The exemplary three way valves 80 associated with the heat recovery heat exchanger 26 and the regenerative heat exchanger 40 allow the gasifier 70 to operate at a constant (or near constant) and user-specified temperature over a wide range of reaction conditions (endothermic to exothermic). The high temperature heat rejection/supply 90 is another tool that helps in controlling the temperature by being an additional heat sink or heat source depending on the reaction conditions in the gasifier 70.

In the depicted embodiment of FIG. 1, high temperature steam 15 can be extracted before it enters the gasifier 70 to be used for hydrogen production 100 (via high temperature electrolysis or other suitable decomposition method). The high temperature steam may also optionally be used to feed a steam methane reformer for the production of hydrogen. Product hydrogen can then be sold directly, or used as a chemical reactant to drive various reactions such as the Haber-Bosch process or reverse water gas shift reaction. If a reverse water gas shift reaction is used, the hydrogen can be used to break down CO₂, and allow it to be turned into a suitable feedstock for synthetic fuel production or other reactions where CO and H₂ are suitable reactants, such as direct reduction of iron 110 or Fischer-Tropsch synthesis.

The gasifier 70 takes in a suitably prepared carbonaceous feedstock 120, such as but not limited to, low caking coal, biomass, or other carbonaceous feedstock and catalytically reacts it with water to form a low BTU synthetic gas. For instance, example synthetic product gases include CO, H₂, and CH₄ with or without the presence of an external oxygen source. The anaerobic reaction allows almost complete conversion of the carbonaceous feedstock 120 to synthetic gas 130 as the heat from the nuclear reactor (or thermal input device 5) is sufficient to maintain gasification temperature. Operating conditions in an anaerobic mode also minimizes the emissions of CO₂ to the atmosphere or CO₂ for sequestration 140. This is because CO₂ is produced solely as a byproduct of the gasification reaction and not as a byproduct of heat production. Additionally, there may be instances in which it is economically attractive to limit the heat input from the nuclear reactor. At such instances, boost oxygen or air can be added to the reaction to make it more exothermic as desired.

Presently, known gas separations require the gas to be at lower temperatures (such as <200° C.). Because of this restriction and the desire to remove H₂O, NH₃, H₂S and SOₓ early in the cooling process the product gas is cooled as needed to achieve the necessary temperatures. There may be developments in gas separation technology where it will become economical to separate the gas at elevated temperatures and used to feed other reactions. Should such capabilities develop, this type of gas separation can be completed at any point after the syngas is produced. There are other reactions such as the direct reduction of iron where it is thermodynamically advantageous to not cool the syngas prior to chemical use. In such instances, syngas separation, with or without cooling, and with or without additional heating is optional to achieve the satisfactory state for the required chemical reaction. As a generalized example—in the case of direct reduction of iron 110—the syngas would be heated by combusting a portion of the syngas recovered from the reduction reactor in a pure oxygen stream (or in atmospheric air) and then utilize the heat of combustion to achieve the necessary temperature for the reaction. The combusted gas can then be returned to the heat recovery heat exchanger 26 where it is used to add heat to the gasification reaction.

The effluent gas from the heat recovery heat exchanger 26 may contain gases such as CO, H₂, CH₄, CO₂, SO_{N}, H₂S, COS, H₂O, N₂, NH₃ among some possible gases in various concentrations. The gases may be separated as needed for use in various reactions. Some example reactions include Fischer-Tropsh, reverse water gas shift, Haber-Bosch process, methane reforming (autothermal or steam), or any other conceivable process where an economic use may be applied. Additionally, the separated gases may be commercially sold at this juncture.

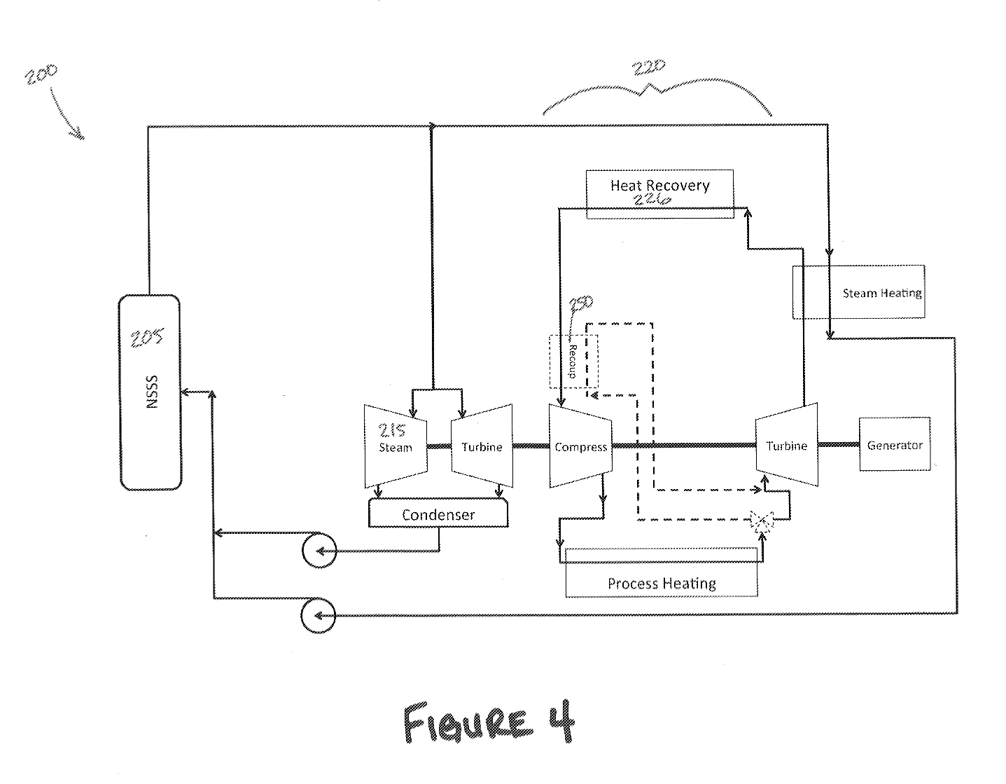

FIG. 4 is an alternative embodiment of another exemplary facility 200 according to the present invention that incorporates the use of the heat pump 220 to amplify the steam (or other working fluid) temperature from a light water reactor 205 operating at a core outlet temperature of about 290° C. with a steam supply temperature at or about 284° C. In alternative embodiments, the core outlet temperature of the light water reactor 205 is between about 250° C. and about 290° C., and more preferably between about 280° C. and about 290° C. The embodiment shown in FIG. 4 incorporates heat recovery 226 from the high temperature application as well as recuperation 250. One of ordinary skill in the art can appreciate a facility at which improvements to cycle efficiency can be made or removed.

The particular depicted example embodiment in FIG. 4 takes heat from a small light water reactor 205 operating at 375 MW(th) supplying steam 215 at about 284° C. and at about 69 bar. The following calculations/states in regards to the exemplary system depicted in FIG. 4 do not include recuperation or heat recovery and serve as a lower bound for cycle efficiency. The heat pump 220 supplies about 140 MW(th) at about 424° C. The heat pump operates at a coefficient of performance (COP) of about 2.99 with the high-pressure side at about 220 bar and the low-pressure side far enough above the critical point to prevent compressor cavitation at about 74 bar. The addition of regeneration (not depicted) or recuperation 250 can add further improvements to cycle efficiency. The operation of the high-pressure side between about 424° C. and 287° C. allows the incorporation of energy storage using a salt or any other suitable media such as “solar salt.”

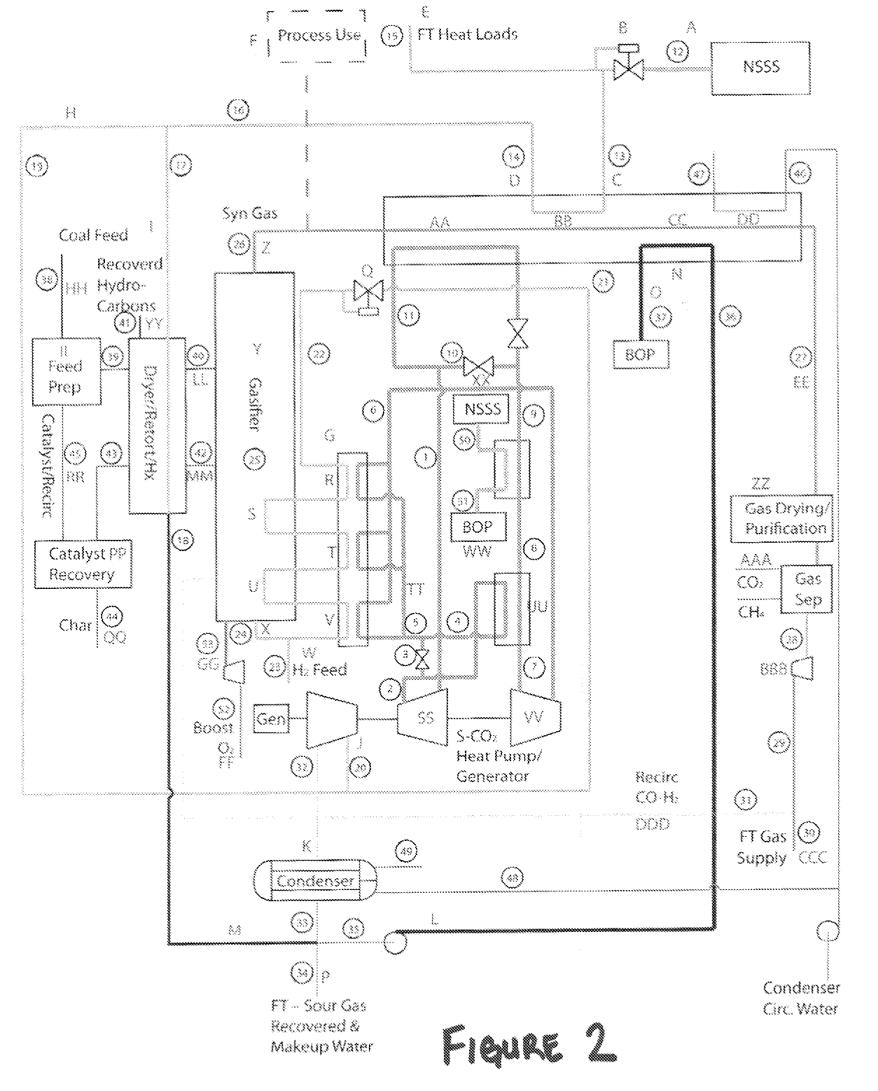

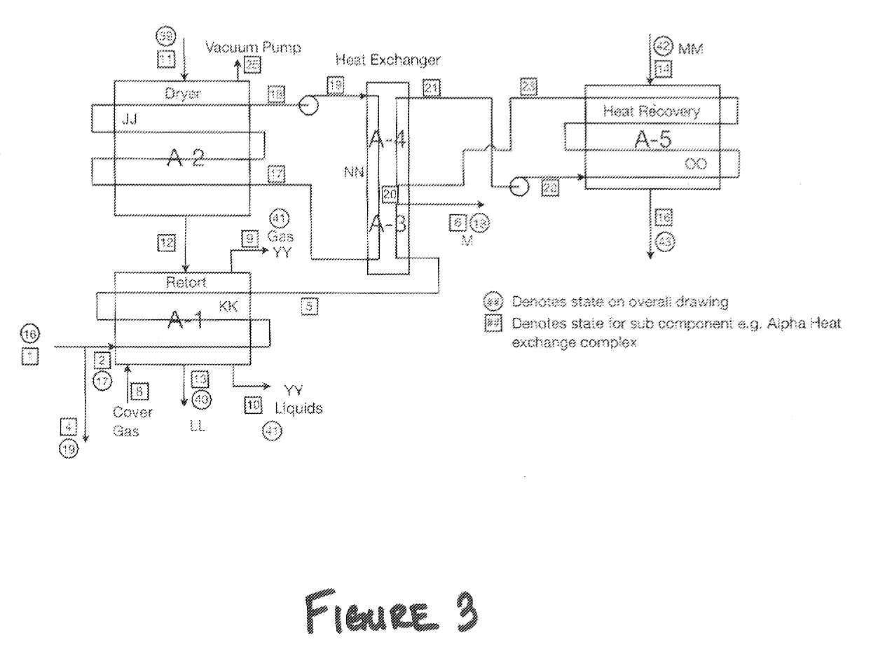

With specific reference now to FIG. 2, the following narrative describes exemplary steps of a system and method according to particular example embodiments of the present invention:
STEP A. A working fluid is supplied from a nuclear fission reactor (alternatively, any steam generator or thermal input device can be used). In the depicted embodiments, the working fluid is steam, however, in alternative example embodiments the working fluid can be methane or other compatible fluids. The steam used is also a chemical reactant for the process. In this application, it is beneficial to use steam as a chemical reactant and working fluid. While the nuclear fission reactor can be a thermal light water reactor, a metal cooled reactor (e.g. sodium, lead, lead-bismuth), a salt cooled reactor, or a High Temperature Gas Cooled Reactor (HGTR), the described embodiment of the present invention is tailored to a sodium fast reactor with a preferred core outlet temperature of less than about 650° C., and more preferably between about 450° C. and about 650° C., and still more preferably between about 450° C. to about 550° C., and steam pressure ranging from about 68 bar to about 147 bar. In other embodiments, the core outlet temperature can be less than about 600° C. In preferred example embodiments, steam supplied from a Nuclear Steam Supply System (NSSS) at about 147 bar and about 452° C. is utilized. However, one of ordinary skill in the art will appreciate that a wide range of steam temperatures and pressures can be utilized as desired, for example, a wide range of steam temperatures between about 450° C. and about 650° C. can be utilized with known working materials (e.g. 316 stainless steel, alloy 617, or alloy 230). It is contemplated that higher working steam temperatures and/or pressures can be utilized with an advancement of working materials. The aforementioned preferred steam temperatures of about 450° C. to about 550° C. and pressures of between about 68 bar to about 147 bar is generally based on a nuclear power plant design by GE Hitachi Nuclear Energy commercially known as S-PRISM, which nominally drives a steam Rankine cycle.
STEP B. The steam undergoes an adiabatic expansion to about 65 bar. The expansion may also be done through the use of a turbine or some other suitable expansion device where useful work may be obtained. If useful work is extracted, the steam may require reheating depending on the needed conditions at the outlet of the expansive device. The schematic shows a straight feed into steps C and E. This is preferred for operating at the NSSS supply conditions, a gasifier temperature of about 600° C., and a gasifier pressure of about 50 bar. If either a (1) higher temperature condition in the gasifier, or (2) a lower temperature NSSS, or (3) a significantly lower gasifier operating pressure, and the steam will have to be reheated to the NSSS supply temperature to maximize the NSSS heat contribution. If needed, this can be done using a heat exchanger similar to a Moisture Separator Re-heater, common in steam-power generation. The preferred pressure of about 65 bar is based off of the gasifier supply pressure and can range from a few bars of pressure to the NSSS supply pressure as desired by an operator. The expansion of the steam at this step also provides adequate steam pressure/superheat to the turbine used in step J. Moreover, the steam pressure at this juncture can also be an effective control of the heat balance in step BB and the temperature of NN, thus preventing carbonization of the coolant used in step JJ. The expansion can also serve as the final pressure control to the gasifier.
STEP C. The steam enters the gasifier exhaust gas cooler (or heat recovery device), where it is preheated to about 540° C. The heat recovery device depicted in FIG. 2 is a compact diffusion-bonded heat exchanger, as such heat exchangers are assumed to be the most economic design and piping configuration. However, in alternative embodiments, other heat exchangers/heat recovery devices can be readily substituted for a series of traditional shell-heat exchanger(s), tube-type heat exchanger(s), or any other type of compatible heat exchanger as desired.
STEP D. The exit steam is being supplied to a Dryer/Retort/Heat Recovery heat exchanger (DRHR), the gasifier, and a heat pump compression turbine.
STEP E. In preferred example embodiments, the coal gasification can be coupled to a Fischer Tropsch (FT) Synfuel facility (not shown), a methanol production facility (not shown), a Haber-Bosch facility, or any other capable facility as appreciated by one of ordinary skill in the art. The steam at this step supplies process heat for those optional reactions.
STEP F. Similar to step 110 of FIG. 1, this step is where the synthetic gas is sent to high temperature applications where product gas separation may not be desired. The return gas from the stream would come back and be in parallel or replace the product gas stream from step Z entering the heat recovery heat exchanger.
STEP G. The heat exchange at this step adjusts the enthalpy of the supercritical CO₂ (S—CO₂) to allow the expansion of the CO₂ to reduce its pressure. As such, once the CO₂ is reheated in step AA and then compressed in step SS, it is at the preferred supply temperature. The example embodiment depicted in FIG. 2 generally limits the temperature of the CO₂ to about 825° C. In alternative embodiments, the CO₂ temperature can be higher as desired and is ultimately constrained by the materials selected by a user.
STEP H. The steam from step D is sent to various processes: step I, J and Q.
STEP I. The steam from step H is supplied to the DRHR. The DRHR configuration uses the steam supplied from the NSSS to dry the feedstock, carbonize the feedstock, and preheat the feedstock to minimize the work done by the heat pump. It has been found that this provides an advantageous synergy and minimizes the work necessary to liquefy the feedstock. An example DRHR that can be used with the present invention is depicted in FIG. 3 and is more fully explained below.
STEP J. In preferred embodiments, a portion of the steam that bypasses the DRHR is used to drive a conventional turbine that is mechanically coupled to the heat pump compressor. In depicted embodiments, the turbine does not include any reheat or extraction steam, however, it is possible for the turbine to also be driven using steam directly from the NSSS. In such embodiments, additional steam cooling from the NSSS from step BB would be required due to the reduced system flow. Additionally, any suitable supply of useful work may be used to drive the heat pump. An example of this could be an electric motor or a turbine driven by some other suitable working fluid.
STEP K. The turbine discharge steam is directly discharged into a condenser. In depicted embodiments, a conventional shell and tube heat exchanger is utilized because of its ability to handle heat transfer during the phase transition of the steam to water. While steam is used as the preferred working fluid in depicted embodiments, at this stage, other example working fluids include Helium, CO₂, or salt. As the turbine in step J is a heat engine, heat is rejected for it to function, step K serves as the mechanism for heat rejection. In other embodiments, a suitable form of heat rejection can be supplied by one skilled in the art and may be substituted at this step.
STEP L. Any low or high-pressure pump combination can be used to effectively combine the process flows from K, M, and P. The condensed steam from steps K and M is generally pressurized to the pressure of the NSSS as would be found at the suction of the feed pumps. In example embodiments, the pressure at this step is roughly equivalent to that of the supply steam pressure.
STEP M. The condensed steam that was used in the DRHR is optionally returned to the suction of the pump.
STEP N. In example embodiments, the product gas is cooled using the condensate from the heat pump compressor turbine. The cooling of the product gas preheats the compressor turbine condensate to a temperature close to the temperature of the Balance of Plant (BOP) feed pump suction or to the saturation temperature of the steam generator. The water entrained in the product gas begins to condense in this heat exchanger. Alternatively, if feed water at a higher pressure is used, then more sensible heat can be removed with the feed water. If too much sensible heat is rejected in step DD, then the NSSS will have to supply steam or some other suitable working fluid for additional cooling at or between steps BB and CC.
STEP O. The water from step N can be discharged to a heater drain tank, a de-aerating feed tank, or directly into a steam generator. Water Quality: of the water that is recovered in sour gas stripping and from the optional Fischer-Tropsch (FT) Synfuel facility, some 60-80% of the water is sent to the gasifier, and has to be purified before being turned into steam. If the water quality requirements of the BOP are too stringent and it is more economical to use NSSS to supply heat to a steam generator dedicated for synfuel recovered water then that is the path that is chosen. Otherwise, the water is purified to BOP requirements and sent to the suction of the feed pumps, directly to the steam generator, or any other compatible location as desired.
STEP P. In example embodiments, make-up water for water consumed in the reaction is supplied here. This can be any combination of fresh make-up water. For example, the make-up water can be water recovered from product gas drying, water recovered from liquid fuel production, or water reused in feedstock preparation.
STEP Q. While the steam pressure of the gasifier is regulated through a pressure regulating valve, as used in preferred example embodiments and depicted in FIG. 2, such a regulating valve can be omitted if the operating pressure of the gasifier is adequate to drive the heat pump compressor turbine. The pressure regulating valve, roughly an adiabatic expansion device, may be substituted for some other suitable expansion device with or without the conversion of heat and/or pressure to useful work. The substitution may or may not require additional temperature adjustment to be suitable for integration into the cycle.
STEP R. When the reaction is Endothermic: The gasifier steam supply is heated from about 590° C. to about 820° C. using a S—CO₂ heat pump. The steam feed is typically heated 3 separate times and cooled twice to add enough sensible heat to the gasifier to finish heating the feedstock and supply enough heat to make up for the heat consumed in the endothermic reaction of the gasifier. The heat added to the gasifier steam supply can be reduced by optionally adding boost oxygen (step GG) if needed or desired. The CO₂ flows to the heat exchangers in steps R, T and V and can be separately regulated to control the gasifier temperature as needed. A maximum of about 826° C. was used in this particular example embodiment depicted in FIG. 2 due to the temperature—pressure restrictions of CO₂ used. However, in alternative embodiments, the CO₂ can be heated to greater temperatures as desired. In such alternative embodiments, the pressure and temperature of the CO₂ may be limited by the materials selected for the gasifier and S—CO₂ heat pump system piping. As the temperature of the steam is increased, fewer numbers of heat exchangers are needed to heat the gasifier. Conversely, as the steam temperature at this step is reduced, additional heat exchangers are needed. Actual temperature limitations may be about 850° C. as the high temperatures and pressures of the S—CO₂ drive material considerations. The temperature of the CO₂ is controlled at steps R and T for the inlet temperature of S and U. and the temperature at step X is set to about 820° C.
   When the reaction is Exothermic: The S—CO₂ at step TT will be at a sufficiently low temperature to be able to remove an adequate amount of heat from the gasifier to maintain the desired temperature. The heat is removed using the regenerator in step UU by using the turbine exhaust gas to cool a portion of the high temperature supply gas. Step R conducts the first gross adjustment to the sensible heat of the steam supplied to the gasifier. This heat exchange is important under exothermic and endothermic gasifier conditions as it is the first point that heat is added or removed from the gasifier feed steam by the Brayton cycle. To limit the complexity of the piping system, it is advantageous to use the supply steam to thermally couple the heat pump to the gasifier product effluent. The heat recovery also ensures that the steam at step H is hot enough to pyrolize the feedstock.
STEP S. In depicted embodiments, the gasifier steam is used to add/remove sensible heat (as needed) to/from the gasifier using a tube sheet that is inside the gasifier. This type of preferred heat exchanger is similar in design to known heat exchangers that are used to boil/superheat water in fluidized bed furnaces. Such a heat exchanger achieves high volumetric heating and high surface heat transfer resulting in a compact heat exchanger. The depicted schematic has two such heat exchangers, although more or less can be added as needed (depicted embodiments are based on anticipated feed stock and desired reactor conditions—e.g. endothermic/exothermic). Note that step U is similar to step S. In depicted embodiments, steam was chosen as the heat transfer fluid because when an eventual steam leak results due to tube sheet erosion, the steam directly aids the gasification reaction. Steam is also compatible with the materials that would be used in this situation (tubes used to boil water and superheat steam in a fluidized bed furnace). Moreover, the operational pressure of the steam is close to the pressure of the gasifier (within a few psia) so a leak mass-flow-rate will be smaller than that of a higher pressure system. This is the main reason why S—CO₂ is not preferred (although S—CO₂ or other working fluids can be used as desired). A leak can be identified by a change in the S—CO₂ flow to the various heat exchangers (steps R, T, and V) and plant operation can be continued until the loss of efficiency drives the economics of shutting the gasifier down for repairs.
STEP T. See step R. For this particular embodiment, the entrance steam temperature in this heat exchanger is about 610° C., but is somewhat dependent on the gasifier heat exchanger design that is chosen for step S.
STEP U. See step S. If the gasifier is operated under exothermic conditions or hydrogen production is desired, the gasifier can be operated at a sufficient temperature to provide high enough temperatures between step U and step V to act as an alternate supply of steam for electrolysis or other high temperature conversion of water to hydrogen or production of hydrogen through the reformation of methane used in step W.
STEP V. This heat exchanger is the final preheating of the steam before directly entering the gasifier. Because hydrogen production may be included to produce CO from the reverse water gas shift reaction (CO₂+H₂=>CO+H₂O), the temperature here is the maximum recommended temperature attainable from the heat pump, which is about 820° C. in this example embodiment. Monitoring the steam temperatures will allow for tube sheet leak detection in the gasifier volumetric heat exchangers. The depicted configuration serves to allow the maximum attainable temperature of the steam to about 820° C. This limitation is based on heat balance of the embodiment, the temperatures supplied by the heat source and the gasifier, and the material limitations. Advances or improvements in any of these will allow higher temperatures.
STEP W. Steam is withdrawn at this step for hydrogen production if desired by a user. The hydrogen produced can either be sold, used in the reverse water gas shift reaction, used for Haber-Bosch process, or fed back into the gasifier (among numerous other possible uses). Any high temperature hydrogen production method is suitable, however, if a user desires to produce hydrogen from the depicted schematic, the gasifier conditions may have to be adjusted to suit the particular hydrogen production technology that is utilized.
STEP X. The steam enters the gasifier and is the fluidizing media for the same. At this point, flow velocity is adjusted by the user in accordance with the particular gasifier selected. Proper flow rate is important to ensure required particle distribution within the gasifier.
STEP Y. This is the gasification reactor. Any gasifier can be selected by the user/operator, including any conventional/known design (however, the present invention contemplates that the embodiments depicted herein can be implemented with enhanced gasifiers as gasifier technology advances). If a non-catalytic gasifier is used in conjunction with the present invention and/or temperatures above 600° C. are needed, the reaction chemistry can be adjusted as appreciated by one of skill in the art. In general, the more exothermic the reaction the higher the temperatures that can be attained in the gasifier, because the heat input into the gasifier is limited by the material constraints of the high-pressure high temperature S—CO₂ with existing state of the art technology. This limits the maximum attainable enthalpy change and mass flow rate of the steam used to heat the gasifier.
STEP Z. In example embodiments, the product gas that emerges from the gasifier is roughly ˜42% H₂O, 24% CO₂, 20% CH₄, 9% H₂, 2% CO, plus small amounts of N₂-0.3%, COS, NH₃ and H₂S. This exemplary product gas occurs in equilibrium conditions and is greatly affected by the reactions' dynamics and the method of gasification chosen. In depicted embodiments, the product gas is nominally about 600° C., but the temperature can vary with conditions and method(s) of gasification. Not depicted on this drawing is particulate separation. It was not included for simplicity in the drawing. It is at this point that the char in the gasifier is separated from the gas, a portion sent back into the gasifier and the remaining balance sent to the DRHR in FIG. 3 step MM.
STEP AA. This step depicts the first cooling heat exchanger within the heat recovery device and can be used to add sensible heat to the low-pressure heat exchanger of the heat pump under endothermic conditions. The temperature needs to be controlled at this point. If the temperature is too high, the temperature increase from the compression of the S—CO₂ may exceed a material limitation, and if the temperature is too low, gasification may not be possible. Flow can be bypassed and/or isolated as needed if the gasifier is exothermic. There may also be the inclusion of a recuperator to provide additional compressor inlet temperature control.
STEP BB. In depicted embodiments, the flow of the steam may be in parallel with the flow of the carbon dioxide (step AA) of the heat pump based on the ultimate needs of the facility for the chosen feedstock range and gasifier reaction conditions. The heat exchange between the CO₂ and the steam is especially pertinent if the reaction is endothermic as step AA may remove too much heat from the output gases such that the steam temperature at step I is unable to pyrolize and adequately preheat the feedstock. To prevent the excess removal of heat a bypass line on the S—CO₂ side of step AA is included. Under exothermic gasifier conditions it may be necessary to remove additional sensible heat between steps BB and CC by the inclusion of an additional heat exchange step heating the high-pressure steam from the NSSS.
STEP CC. The last heat to be recovered is in the turbine condensate.
STEP DD. Heat is optionally rejected to the circulating condenser water or some other suitable media for rejecting heat.
STEP EE. By rejecting heat in step DD, product gas is cooled to about 40° C., or as otherwise desired.
STEP FF. Boost O₂ can be provided from separating oxygen from atmospheric air, utilizing atmospheric air, or gathering O₂ from other steps within the depicted schematic. In any event, the O₂ is preferably compressed before being injected into the gasifier at gasifier conditions (e.g. temp/pressure). The injection of boost O₂ can be used to limit the necessary heat input from the NSSS, which is economically justified when it is more economical to produce electricity than it is to produce syn fuels and/or separate oxygen. It is important to make the point that the use of oxygen (air or pure O₂) can be used to make the reaction exothermic. Oxygen can also be separated from nitrogen that was previously cordoned off prior to entering the gasifier to eliminate the need to separate it later on from the product gas. If N₂ is not separated, then it will have to be removed from the product gas stream. N₂ may interfere with downstream chemical reactions, or if the CO₂ is elected to be sequestered, the inclusion of N₂ would significantly increase the costs of sequestration. The advantage of this technology is that in general it does not require air to achieve the necessary gasification temperatures. In other gasification technologies N₂ is either separated from the product gas or from the supply gas to the gasifier. Because the concentration of N₂ is so low in the product gas separation may not be necessary from the CO₂ for sequestration or from the low BTU product gas that is desired product. The virtual elimination of N₂ from the reaction may obviate the need for the capital investment to separate the N₂.
STEP GG. When utilized, the optional boost O₂ enters the gasifier at about 450° C. It can be preheated further if desired, but it is anticipated that the extra capital cost of increased thermal efficiency may not make additional preheating economical. Such a decision can be evaluated on a case-by-case basis.
STEP HH. The feedstock used in conjunction with the example embodiment depicted in FIG. 2 is subbituminous coal, but can be any low caking carbonaceous material. In preferred example embodiments, the coal is handled and crushed using the existing coal processing facilities (if the option to install this is at a brown field site).
STEP II. The feed is prepared using one or more of the various suitable methods for preparing carbonaceous feedstocks as appreciated by one of ordinary skill in the art.
STEP JJ. The slurry is sent to the dryer of the DRHR, which can be kept at a slight vacuum as it is heated to limit the addition of nitrogen into the gasifier and to remove at least a portion of the available water vapor. Step JJ is seen in FIG. 3.
STEP KK. See FIG. 3 for a depiction of the retort in the DRHR.
STEP LL. The carbonaceous char is now sent to the gasifier by any suitable means. In example embodiments, the char is sent to the gasifier via LL.
STEP MM. The spent char exits the gasifier at a specified exit point in the gasifier. At this stage, the char is nominally about 10% carbon by mass.
STEP NN. See FIG. 3 for a better depiction of step NN. At this step, the coolant used in step JJ can be heated by a combination of heat recovered from step OO and/or by using steam from step I. The steam generally leaves the heat exchanger as a sub-cooled liquid but may be another state if desired. The heat exchange from step OO is optional and may be included in commercial embodiments if economic considerations of the expected (and/or realized) operational conditions are favorable.
STEP OO. As seen in FIG. 3, the char heats a coolant that is thermally coupled to the dryer.
STEP PP. The catalyst is recovered at this stage. The char may optionally be either disposed of or recycled and sent back into the gasifier.
STEP QQ. The char can be disposed of by any convenient manner as appreciated by one of ordinary skill in the art.
STEP RR. The catalyst, and if necessary/desired a portion of the char, can be recycled at this point.
STEP SS. The S—CO₂ is compressed using a compressor, which may be single or multi-staged.
STEP TT. In the depicted embodiments, the S—CO₂ is split into parallel flow and sent to the various heat exchangers preferably via a common supply header. The particular flow path may be adjusted for various compression and turbine configurations. The CO₂ returns to a common return header and may be sent to preheat the compressor suction gas through a recuperative heat exchanger.
STEP UU. The regenerative heat exchanger controls the exit gas enthalpy to allow the heat pump to be able to remove heat from the gasifier by providing a means of being able to cool the compressor discharge gas with the turbine exhaust gas. If the cycle requires removal of the heat, heat may be rejected to the NSSS (step WW). Under endothermic conditions the NSSS may supply additional heat (step WW).
STEP VV. The S—CO₂ undergoes an isenthalpic expansion through some porous media, thermal expansion valve, and/or similar device as appreciated by one of ordinary skill in the art. If the gasifier is to be operated under widely varying conditions, endothermic to exothermic, the isenthalpic expansion can be replaced with a turbine. This allows for sensible heat to be converted into mechanical energy that can minimize the steam turbine input (step J) or it can be used to produce electricity under exothermic conditions. The turbine may contain multiple stages.
STEP WW. Depending on the gasifier state, sensible heat can either be transferred from the NSSS high-pressure steam to the S—CO₂ or it can be transferred to the NSSS high-pressure steam. This step is optional if the turbine in step VV is replaced with an isenthalpic expansion device (as can be implemented in alternative example embodiments).
STEP XX. This valve arrangement depicted in FIG. 2 provides the ability to isolate and/or bypass the heat exchanger used in step AA, which can be advantageous if the gasifier is operated under exothermic conditions.
STEP YY. In example embodiments, the recovered hydrocarbons, gas and/or liquids, can (1) be sent to gas drying and purification (step ZZ), (2) sent for further processing (step CCC), (3) used and/or sold, (4) and/or sent back into the gasifier for further conversion.
STEP ZZ. The gas drying and purification can be implemented via various configurations, including, but not limited to, mechanical power coming from steps VV and J, NSSS steam, equipment driven by electrical means, expansion of the gas (from step EE, with or without cooling from step DD) used in a turbine, or any convenient method as understood by one skilled in the art. The physical processes of purification can comprise any effective and/or known method as desired by a user/operator.
STEP AAA. The power described in step ZZ may also be used in step AAA. The product gas can be separated by any known or convenient means. The CO₂ can be combined with the hydrogen from step W or with hydrogen generated from the steam reforming of methane, or any other convenient source of hydrogen under the reverse water gas shift reaction to produce CO and water. This product stream can then be sent back into the gasifier or for use in other chemical reactions or direct sale. The CO₂ may be sequestered, disposed of in the atmosphere, used as a reactant (reverse water gas shift reaction), or put to some other economic use. A portion of the methane product gas can be steam reformed using any convenient source of steam at adequate pressure, preferably from step H. The reformed gas may then be reintroduced to the gasifier or sent to some other convenient or economic purpose. The product gas or the methane may need to be compressed for its intended use and may be done by any process similar to that described in conjunction with step BBB.
STEP BBB. The product gas can be compressed to any convenient pressure based on the downstream use. Compression of the product gas can be achieved by any effective means of compressing a gas as widely appreciated by one of ordinary skill in the art.
STEP CCC. At this step, the gasifier product gas (nominally CO and H₂) is sent to any desired downstream process—depending on the intended use. The H₂ to CO ratio can be adjusted by adjusting the gasifier parameters, methane steam reforming, or via other methods as necessary to meet the need of the particular downstream process.
STEP DDD. If desired by a user, the CO and H₂ may optionally be recycled into the gasifier.

The Dryer/Retort/Heat Recovery (DRHR) device utilized in conjunction with the present invention (and the exemplary nuclear plant described above in conjunction with FIG. 2) is depicted in greater detail in FIG. 3. There are generally two main parallel flows of feedstock entering the gasifier and char leaving the gasifier—involving heat exchange between solid-gas, gas-liquid, and liquid-solid. Because of the heat involved, soft ash carbonaceous material (i.e. coking coal) may not be suitable for gasification due to the potential for caking and subsequent flow blocking. Of the feedstock flow there is a high temperature side (>350° C.) and a low temperature side (≦350° C.). The low temperature side is thermally coupled using a oil coolant at up to 350° C. (i.e. Dynalene HT) but can be any other suitable coolant as desired. Generally, 350° C. also serves as the boundary between drying and pyrolysis, however, that boundary may exist at temperatures less than 350° C. The feedstock drying can be done under atmospheric conditions or under a slight vacuum to serve as a nitrogen barrier for the gasifier, enhance water recovery, and capture any possible volatile material not captured in step YY during pyrolysis. The high temperature side uses the feed steam that will eventually enter the gasifier. The steam is used as the coolant of choice (although other coolants can be used), because when a tube leak develops the steam leak is compatible with the feedstock and will only be a loss in overall efficiency and not otherwise detrimental to the chemical and thermodynamic processes. The steam provides any additional heat to the low temperature feedstock drying that is not recovered from the discharged char. The oil coolant that is used in the drying process can also be heated from the discharged char through thermal coupling with an intermediate loop.

A vacuum pump can be used, as shown, to draw the evolved water and any entrained gaseous nitrogen. The retort carbonizes the feedstock. Once carbonized, the evolved hydrocarbons are either sold directly or further refined in the FT system. The cover gas utilized with the present invention can be either CO₂ or H₂. Generally, it is recognized that H₂ will boost hydrocarbon output of this system.

The various states (States 1-53) of the nuclear facility of FIG. 2 and FIG. 3 have been approximated and are shown and described in Table 1 below.

TABLE 1

| | Tᵢ | Pᵢ | \dot{m}ᵢ | T_{A,i} | P_{A,i} | \dot{m}_{A,i} | T_{B,i} | P_{B,i} | \dot{m}_{B,i} |
|---|---|---|---|---|---|---|---|---|---|
| State # | [K] | [bar] | [kg/s] | [K] | [bar] | [kg/s] | [K] | [bar] | [kg/s] |
| 0 | 298.2 | 1.013 | | | | | | | |
| 1 | 868 | 74 | 100 | 869 | 65 | 27.61 | 873 | | |
| 2 | 1100 | 286.1 | 100 | 869 | 65 | 2.82 | 873 | 49.31 | 16.5 |
| 3 | 1100 | 285.2 | 33.65 | 869 | 65 | 24.79 | 677.9 | 48.97 | 16.5 |
| 4 | 741.2 | 285.2 | 66.35 | | | | 339.6 | 48.62 | 10.86 |
| 5 | 863.3 | 285.2 | 100 | 565.5 | 63 | 2.82 | 303.2 | 48.28 | 10.82 |
| 6 | 868 | 283.2 | 100 | 323.4 | 61 | 2.82 | | | |
| 7 | 716.1 | 78 | 100 | | | | | | |
| 8 | 967.5 | 76 | 100 | 800 | 50 | 0 | | | |
| 9 | 868 | 74 | 100 | 546 | 50 | 0.9155 | | | |
| 10 | 868 | 74 | 100 | 773 | 50 | 0.6599 | | | |
| 11 | 868 | 74 | 0.001223 | 298.2 | | | | | |
| 12 | 725.2 | 147.2 | 27.65 | 546 | | 6.753 | | | |
| 13 | 673.9 | 65.69 | 27.61 | 773 | | 5.528 | | | |
| 14 | 869 | 65 | 27.61 | 873 | | 0.3864 | | | |
| 15 | 673.9 | 65.69 | 0.03903 | | | | | | |
| 16 | 869 | 65 | 27.61 | 320.2 | | | | | |
| 17 | 869 | 65 | 2.82 | 556 | | | | | |
| 18 | 323.4 | 61 | 2.82 | 308.2 | | 8.358 | | | |
| 19 | 869 | 65 | 24.79 | 308.2 | | 8.358 | | | |
| 20 | 869 | 65 | 13.43 | 321.4 | | | | | |
| 21 | 869 | 65 | 11.36 | 310.2 | | | | | |
| 22 | 864.1 | 51.31 | 11.36 | 310.2 | | 0.1802 | | | |
| 23 | 858.3 | 50 | 0 | 573.2 | | | | | |
| 24 | 858.3 | 50 | 11.36 | | | | | | |
| 25 | 873 | 50 | 16.5 | | | 2.131 | | | |
| 26 | 873 | 50 | 16.5 | | | | | | |
| 27 | 313.2 | 48.28 | 16.5 | | | | | | |
| 28 | | | | | | | | | |
| 29 | | | | | | | | | |
| 30 | | | | | | | | | |
| 31 | | | | | | | | | |
| 32 | 331.9 | 0.1881 | | | | | | | |
| 33 | 329.9 | 0.1881 | 13.43 | | | | | | |
| 34 | 298.2 | 1.013 | 11.4 | | | | | | |
| 35 | 316.3 | 0.1881 | 27.65 | | | | | | |
| 36 | 318.7 | 148.2 | 27.65 | | | | | | |
| 37 | 608.8 | 147.2 | 27.65 | | | | | | |
| 38 | 298.2 | | 8.781 | | | | | | |
| 39 | 298.2 | | 8.459 | | | | | | |
| 40 | 773 | | 5.528 | | | | | | |
| 41 | | | 1.575 | | | | | | |
| 42 | 873 | | 0.3864 | | | | | | |
| 43 | 320.2 | | 0.3864 | | | | | | |
| 44 | 298.2 | | 0.3864 | | | | | | |
| 45 | 298.2 | | 0 | | | | | | |
| 46 | 298.2 | 2.047 | 20.69 | | | | | | |
| 47 | 327.2 | 1.013 | | | | | | | |
| 48 | 298.2 | 2.047 | 244.4 | | | | | | |
| 49 | 328 | 1.013 | | | | | | | |
| 50 | 725.2 | 147.2 | 18.96 | | | | | | |
| 51 | 962.5 | 147.1 | 18.96 | | | | | | |
| 52 | 298.2 | 1.3 | 0 | | | | | | |
| 53 | 801.7 | 50 | 0 | | | | | | |

While the invention has been described with reference to preferred and example embodiments, it will be understood by those skilled in the art that a variety of modifications, additions and deletions are within the scope of the invention, as defined by the following claims. For example, disclosed embodiments depict various configurations of individual plant components. Numerous other configurations are contemplated that generally incorporate the individual components disclosed herein (with fewer or additional components). Additional steps, phases, components, embodiments etc. as appreciated by one of ordinary skill in the art are incorporated herein, as well as modifications to the example embodiments presented.

What is claimed is:

1. A system for producing consumable fuels comprising:
a thermal input device operable to heat a working fluid;
a heat pump operable to amplify the temperature of the working fluid;
means for delivering the working fluid to a gasifier, wherein the gasifier converts a carbonaceous feedstock into at least one product fluid; and
a product gas heat recovery device operable to at least partially recover heat from the product fluid;
wherein at least a portion of the product fluid is used to produce a consumable fuel.

2. The system of claim 1, wherein the thermal input device is a nuclear reactor.

3. The system of claim 2, wherein the nuclear reactor is a sodium fast reactor and has a core outlet temperature of less than about 650° C.

4. The system of claim 2, wherein the nuclear reactor is a sodium fast reactor and has a core outlet temperature of between about 450° C. to about 650° C.

5. The system of claim 2, wherein the nuclear reactor is a light water reactor has a core outlet temperature of between about 250° C. and about 290° C.

6. The system of claim 1, wherein the thermal input is derived from a solar thermal energy device.

7. The system of claim 1, wherein the conversion temperature of the gasifier is between about 600° C. to about 850° C.

8. The system of claim 7, wherein the conversion temperature of the gasifier is between about 600° C. to about 800° C.

9. The system of claim 1, wherein the working fluid is steam.

10. The system of claim 9, wherein the gasifier chemically reacts the steam with at least one additional reactant to generate the at least one product fluid.

11. The system of claim 10, wherein the at least one product fluid is selected from sulfur oxides, hydrogen, methane, carbon monoxide, carbon dioxide, hydrogen sulfide, carbonyl sulfide, ammonia, and combinations thereof.

12. The system of claim 1, wherein the at least one consumable fuel is selected from the group consisting of kerosene, diesel, gasoline, methanol, or ethanol.

13. The system of claim 1, wherein the carbonaceous feedstock is low coking coal.

14. The system of claim 1, wherein the carbonaceous feedstock is selected from the group consisting of coal, biomass, or carbon dioxide.

15. A system for producing a consumable chemical byproduct comprising:
a nuclear fueled steam supply device operable to produce steam;
at least one heat pump operable to increase the temperature of the steam before it is delivered to a chemical reactor; and
means for delivering the steam to the chemical reactor, wherein the steam undergoes at least one chemical reaction;
wherein at least one consumable chemical byproduct is created by the at least one chemical reaction.

16. The system of claim 15, further comprising a heat recovery device in thermal communication with the chemical reactor, said heat recovery device operable to recover heat from the at least one chemical byproduct.

17. The system of claim 15, further comprising a feed dryer and a feed retort.

18. The system of claim 15, wherein the chemical reactor is a gasifier.

19. The system of claim 18, wherein the gasifier operates between about 600° C. and about 850° C.

20. The system of claim 15, wherein the outlet temperature of the nuclear steam supply device is less than about 650° C.

21. The system of claim 15, wherein the outlet temperature of the nuclear steam supply device is between about 450° C. and about 650° C.

22. A method of producing consumable fuels, comprising:
heating a working fluid using a nuclear reactor;
raising the temperature of the working fluid with a heat pump;
delivering the working fluid to a gasifier, wherein the gasifier converts a carbonaceous feedstock into at least one product fluid;
passing the product fluid through a product gas heat recovery device to at least partially recover heat from the product fluid; and
converting the product fluid into a consumable fuel.

23. The method of claim 22, wherein the working fluid is steam.

24. The method of claim 22, wherein the nuclear reactor is a sodium fast reactor.

25. The method of claim 24, wherein a core outlet temperature of the nuclear reactor is between about 450° C. and about 650° C.

26. The method of claim 24, wherein a core outlet temperature of the nuclear reactor is between about 450° C. and about 600° C.

27. The method of claim 22, wherein the nuclear reactor is a light water reactor.

28. The method of claim 27, wherein a core outlet temperature of the nuclear reactor is between about 250° C. and about 290° C.

29. The method of claim 27, wherein a core outlet temperature of the nuclear reactor is between about 280° C. and about 290° C.

30. The method of claim 22, wherein the heat pump is a Brayton Cycle heat pump.

31. A system for producing consumable chemical byproducts comprising:
a solar thermal energy supply device operable to produce steam;
at least one heat pump operable to increase the temperature of the steam before it is delivered to a chemical reactor; and
means for delivering the steam to the chemical reactor, wherein the steam undergoes at least one chemical reaction;
wherein at least one consumable chemical byproduct is created by the at least one chemical reaction.

32. A system for the generation of consumable fuels comprising:
a nuclear fission reactor to supply steam, the nuclear fission reactor having a core outlet temperature of less than about 650° C.;
a gasifier to produce synthetic consumable fuels, the gasifier operable at between about 600° C. to about 800° C.;
a Brayton cycle heat pump to regulate gasifier conditions;
a product gas heat recovery device to recover and/or cool the consumable fuels.
